(19) United States
(12) Patent Application Publication
(10) Pub. No.: US 2007/0212206 A1
(43) Pub. Date: Sep. 13, 2007

(54) Recreational vehicle portable handicap lift

(76) Inventors: Robert L. Milne, Alamogordo, NM (US); Robert L. Milne, Alamogordo, NM (US)

Correspondence Address: Robert Milne, 1421 Juniper Ave, Alamogordo, NM, 88310, US

(21) Appl. No.: 11/716,779

(22) Filed: Mar. 9, 2007

Related U.S. Application Data
(60) Provisional application No. 60/782,189, filed on Mar. 13, 2006.

(51) Int. Cl. B66B 9/08; B60P 1/00

(52) U.S. Cl. 414/545; 187/200

(57) ABSTRACT

A portable lift designed for a person with limited mobility to independently gain access to and from a recreational vehicle. This easily installed lift allows a person to raise him or herself to the floor level of a recreational vehicle. The front ramp contains a chain which when hooked inside the lift prevents the user from inadvertently rolling off the platform. The lift breaks down into simple sections that can be placed in storage compartments for travel. The permanent mounting brackets allow the lift to be installed within five minutes.

### CROSS-REFERENCE

This application claims the benefit of PPA 60/782,189 filed Mar. 13, 2006

### FEDERALLY SPONSORED RESEARCH

Not applicable

### SEQUENCE LISTING

Not applicable

### BACKGROUND OF THE INVENTION

### Field of the Invention

This invention relates to recreational vehicles and their inaccessibility to persons who are mobility impaired or confined to a wheelchair.

My grandson's wife is confined to a wheelchair. In 2004, they purchased a recreational vehicle. The only way she could get into the vehicle was for him to carry her up the stairs. When they returned from their first trip, they searched for a way to lift her wheelchair up to the floor level of the vehicle. This lift would need to be portable so it could be safely stored when the vehicle is in motion. They were unsuccessful. He asked if I knew of anything as I have been in the sales and service of recreational vehicles for 30 years. I could not find anything, so I jokingly told him I would make him one.

I researched the way other lifts are installed in vans and buses, but to be practical for a recreational vehicle (motor home or travel trailer) it should be portable. This is where my lift comes in. It can be installed in less than five minutes, disassembled, and put in a storage compartment again in less than five minutes. It can also be used as a personal lift for people who are unable to climb steps, as most travel trailers are 36 inches off the ground.

### BRIEF SUMMARY OF THE INVENTION

The patented chair lifts that I have researched are stationary mounts. They are raised and lowered by cable, chain, or hydraulic methods. My lift uses a gear and gear rack and crawls up and down. It has an adjustable stop on the way up and on the way down.

My lift is a simple, easily installed, and disassembled transportable frame and platform, which can be attached to a recreational vehicle to enable a user having limited lower body mobility to safely move from ground level to entry floor level. The apparatus includes permanent mounting brackets to secure the lift to the vehicle. Vertical lift rails attach to the mounting brackets. Quick release pins allow the unit to be removed for storage. A lower brace is mounted to the recreational vehicle step for added stability. The lift platform is comprised of a handrail, a rear floor that includes the power train, an interconnecting front floor, and a front ramp. It operates with a 12 volt motor and is gear and chain driven. The control switch is mounted on the handrail. A handle control assembly with a main switch control is available for persons with limited mobility.

### BRIEF DESCRIPTION OF THE SEVERAL VIEWS OF THE DRAWING

FIG. 1 is a perspective of the lift with part descriptions in the raised position.

FIG. 2 is a perspective of the lift in the down position.

FIG. 3 is a breakdown of the parts shown as assembled.

FIG. 4 is a breakdown of the parts shown as disassembled.

FIG. 5 is a perspective of both sides of the rear floor assembly.

FIG. 6 is an exploded view of the rear floor assembly.

FIG. 7 is the personal lift operational handle.

FIG. 8 is the electrical diagram.

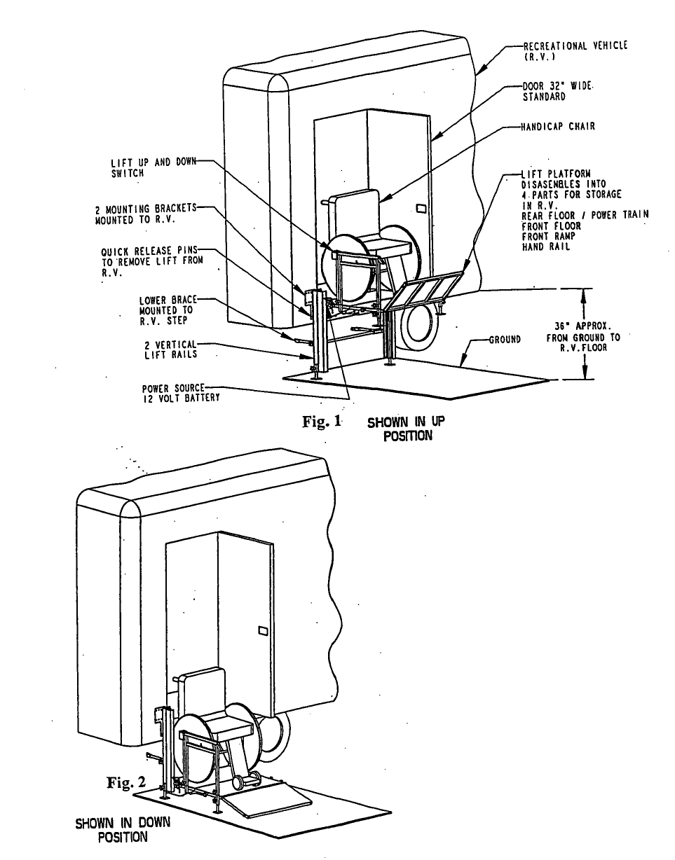

### DETAILED DESCRIPTION OF THE INVENTION

The invention provides a powered platform for the transportation of a person or person in a wheelchair, weighing no more than 250 pounds, between two levels, ground level and floor level of a recreational vehicle.

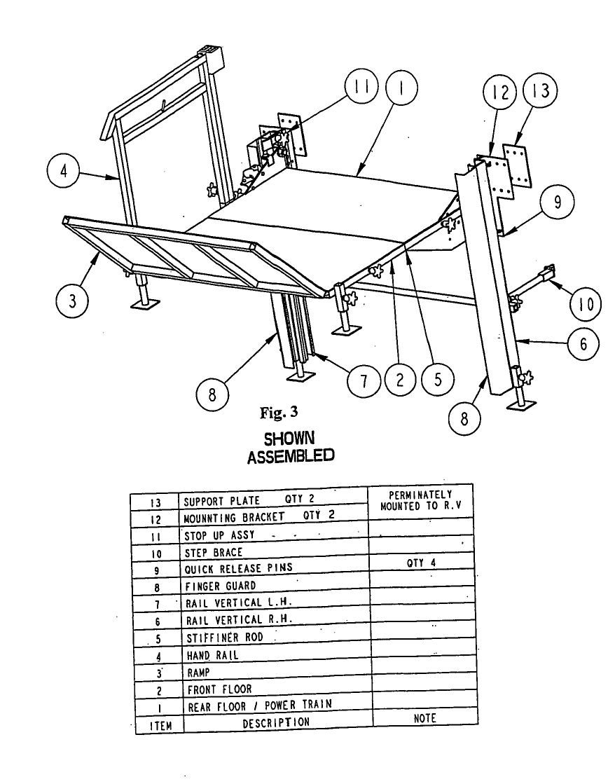

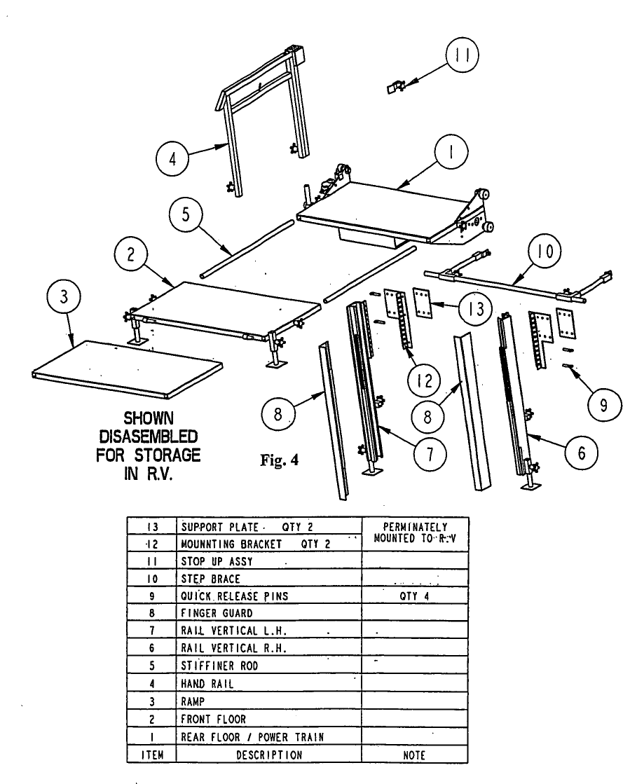

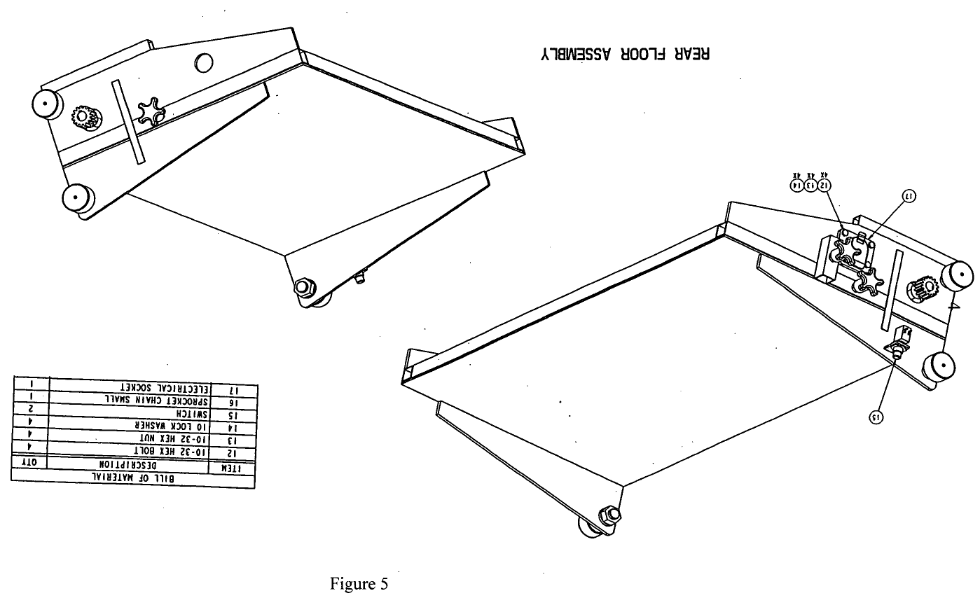

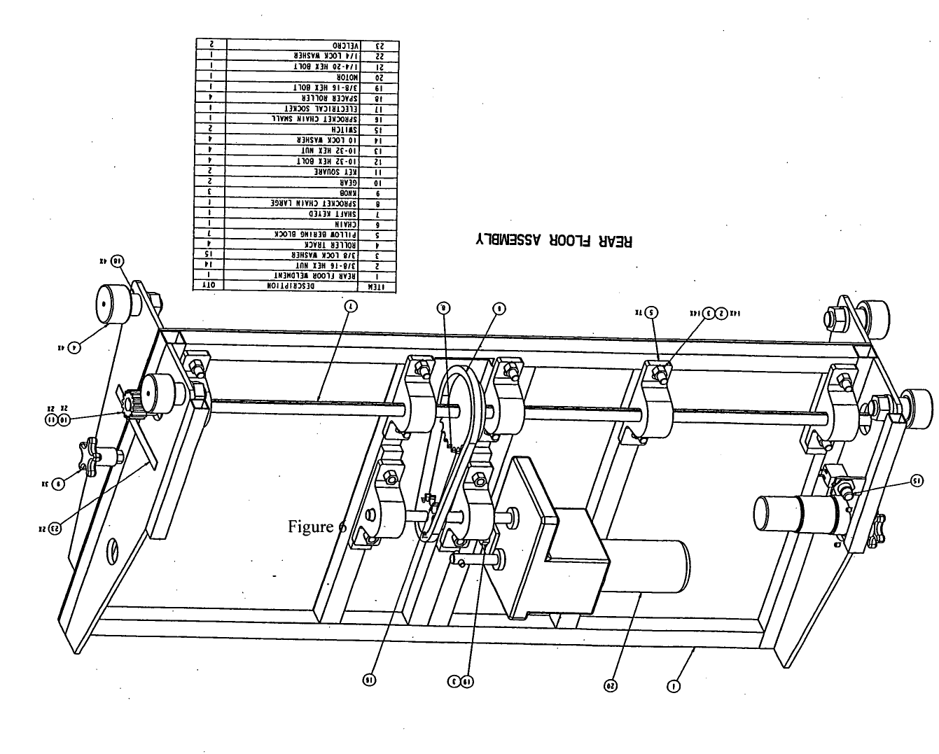

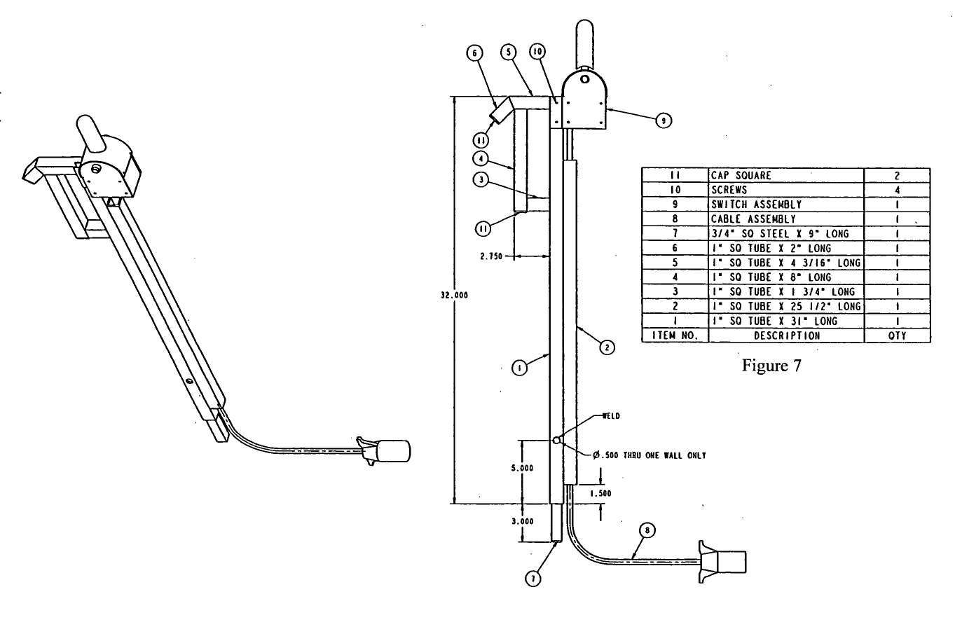

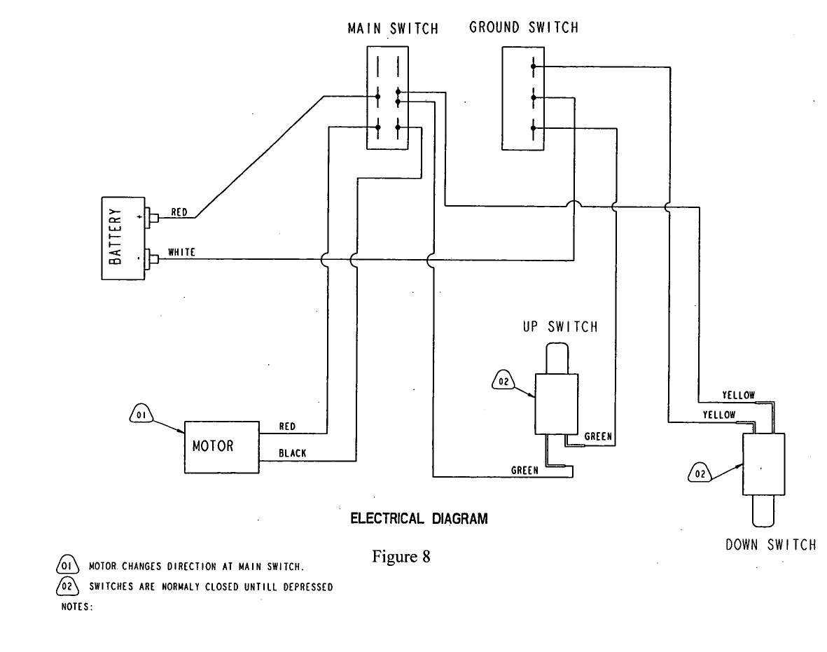

Referring to FIG. 3 item #12 Right and left outside mounting brackets are installed, they line up on the floor line and are bolted with large bolts (4) each side. The bolts need to be a little loose to allow for assembly. Item #13 Support plates, if needed, are bolted all the way to the doorpost and floor line. Item #10 Step brace is bolted to the step. Item #6 Right hand vertical rail is then put in place and held with a item #9 quick release pin. Item #7 Left hand vertical rail is put in place and held with a item #9 quick release pin. Item #1 Rear floor/Power train is set in vertical rails. The rear floor assembly is the working part of the lift. There are seven pillow block bearings, five on the main shaft and two on the motor shaft. These bearings have a dynamic load cap of 2150 pounds each. The outside rollers that run up and down inside the track have a dynamic load cap of 6400 pounds each. The 12-volt motor and gearbox with small chain sprocket on motor shaft and larger on main steel shaft runs by #40 chain. On the 12-volt system that operates the motor, there is one hot wire from the battery. The rest is all ground. The motor is reversible, by reversing the polarity at the main switch. There is a down switch and an up switch that cut the voltage when depressed. Item #4 Handrail is set in place and plugged into the 12-volt power supply. Run the floor up and down to center in vertical rails. Tighten hand nuts and install second pins. Install Item #5 stiffener rods. Install Item #2 front floor and tighten hand nuts. Install Item #3 ramp. Item #11 stop up assembly is configured. Raise lift to floor level and set shut off so it cuts off power at floor line. Install item #8 finger guards with Velcro.

The unit is now ready for use. After initial set up, it can be installed in less than five minutes and broken down for storage in about the same amount of time.

1. A lift apparatus, comprising:
a pair of vertical rails mounted with brackets and supported with a step brace to a recreational vehicle, and
a floor unit with a gear driven power train and hand rail with power switch attached to the rails, and
a handle for use by persons with limited mobility,
whereby a person can be lifted from the ground floor to the entry level of a recreational vehicle.
